(19) United States
(12) Patent Application Publication
(10) Pub. No.: US 2004/0003321 A1
(43) Pub. Date: Jan. 1, 2004

(54) Initialization of protected system

(76) Inventors: Andrew F. Glew, Sunnyvale, CA (US); James A. Sutton, Portland, OR (US); Lawrence O. Smith, Beaverton, OR (US); David W. Grawrock, Aloha, OR (US); Gilbert Neiger, Portland, OR (US); Michael A. Kozuch, Export, PA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/185,123

(22) Filed: Jun. 27, 2002

(51) Int. Cl. H04L 1/22

(52) U.S. Cl. 714/27

(57) ABSTRACT

A system is initialized for operation in a protected operating environment by executing authenticated code that prepares various portions of the hardware for protection from non-trusted software. In one embodiment, initialization includes identifying and locking down specified areas of memory for protected processing, then placing trusted software into the specified areas of memory and validating the trusted software. In a particular embodiment, initialization may also include deriving and protectively storing identifying characteristics of the trusted software.

### BACKGROUND

Computing devices execute firmware and/or software code to perform various operations. The code may be in the form of user applications, BIOS routines, operating system routines, etc., which are vulnerable to corruption by viruses and other third party software. Such corruption, which is typically deliberate, may simply interfere with the normal operation of the system, may destroy files and other important data, and may even be used to surreptitiously gain access to classified information. Various security measures have been developed to protect computer systems from such software corruption. However, to provide uniformity across many platforms, most of these measures rely strictly on security software to find the harmful software and prevent its harmful effects, with little or no protection built into the platform itself. Since the security software may also be subject to software attack, the software-only security measures cannot be completely relied upon to protect the system. In particular, the memory in which the security software is running may be accessed by hostile software that changes the security software, either while the security software is being loaded or while it is running. Monitoring software that is designed to detect such changes may also be altered in a similar manner, possibly disabling the supposedly secure operating environment in ways that may not even be detected.

### BRIEF DESCRIPTION OF THE DRAWINGS

The invention may be understood by referring to the following description and accompanying drawings that are used to illustrate embodiments of the invention. In the drawings:

FIG. 1 shows a computer system, according to one embodiment of the invention.

FIG. 2 shows components of an authenticated code module, according to one embodiment of the invention.

FIG. 3 shows a flowchart of a process to prepare a system for operating in a protected operating environment, according to one embodiment of the invention.

FIGS. 4A, 4B show a flowchart of a process to execute authenticated code, according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Various embodiments of the invention prepare a system for execution of trusted software by validating and/or configuring various hardware and software elements to collectively provide a protected operating environment for the trusted software to operate in. Trusted software is software that has been validated through some means to verify it has not been altered in an unauthorized manner before execution.

Embodiments of the invention may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

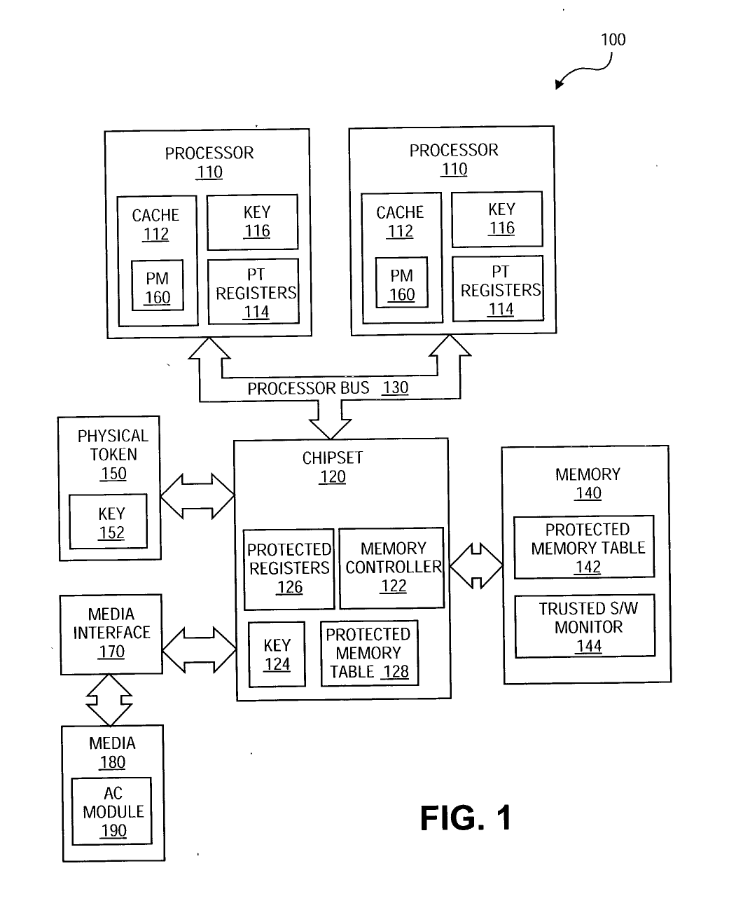

FIG. 1 shows a computer system, according to one embodiment of the invention. System 100 of the illustrated embodiment includes one or more processors 110, a chipset 120 connected to processors 110 via processor bus 130, a memory 140, a physical token 150, a media interface 170 and a media 180. Although FIG. 1 shows two processors 110, various embodiments may have one, three or more processors 110. Each processor 110 may have various elements, which may include but are not limited to, embedded key 116, page table (PT) registers 114 and cache memory (cache) 112. All or part of cache 112 may include, or be convertible to, private memory (PM) 160. Private memory is a memory with sufficient protections to prevent access to it by any unauthorized device (e.g., any device other than the associated processor 110) while activated as a private memory. In the illustrated embodiment, cache 112 may have various features to permit its selective isolation as a private memory. In an alternate embodiment not shown, private memory 160 may be external to and separate from cache memory 112, but still associated with processor 110.

Key 116 may be an embedded key to be used for encryption, decryption, and/or validation of various blocks of data and/or code. PT registers 114 may be a table in the form of registers to identify which memory pages are to be accessible only by protected code and which memory pages are not to be so protected.

Memory 140 may include system memory for system 100, and in one embodiment may be implemented as volatile memory commonly referred to as random access memory (RAM). As illustrated in FIG. 1, memory 140 may contain protected memory table 142 and trusted software (s/w) monitor 144. In some embodiments, protected memory table 142 is a table to define which memory blocks (where a memory block is a range of contiguously addressable memory locations) in memory 140 are to be inaccessible to direct memory access (DMA) transfers. Since all accesses to memory 140 go through chipset 120, chipset 120 may check protected memory table 142 before permitting any DMA transfer to take place. In a particular embodiment, chipset 120 may use caching techniques to reduce the number of necessary accesses to protected memory table 142. In one embodiment, protected memory table 142 may be implemented as a table of bits, with each bit corresponding to a particular memory block in memory 140 (e.g., each bit may correspond to a single page, with a logic ‘1’ indicating the page is protected from DMA transfers and a logic ‘0’ indicating the page is not so protected). In a particular operation, the memory blocks protected from DMA transfers by protected memory table 142 may be the same memory blocks restricted to protected processing by PT registers 144 in processor 110.

Memory 140 may also include trusted s/w monitor 144, which may monitor and control the overall protected operating environment once the protected operating environment has been established. In a particular embodiment, the trusted s/w monitor 144 may be located only in memory blocks that are protected from DMA transfers by the protected memory table 142, thus assuring that the trusted s/w monitor cannot be compromised by DMA transfers from unprotected and/or unauthorized devices. The protected memory table 142 may also protect itself from alteration by DMA transactions by protecting the memory blocks containing the protected memory table 142.

Chipset 120 may be a logic circuit to provide an interface between processors 110, memory 140, physical token 150, media interface 170, and other devices not shown. In one embodiment, chipset 120 is implemented as one or more individual integrated circuits, but in other embodiments, chipset 120 may be implemented as a portion of a larger integrated circuit or it may be implemented as parts of multiple other integrated circuits. Although labeled herein as a “chipset”, this label should not be read as a limitation on how chipset 120 may be physically implemented. Chipset 120 may include memory controller 122 to control accesses to memory 140, key 124 to be used in various encryption, decryption and/or validation processes, protected registers 126, and protected memory table 128. In one embodiment, the protected memory table is implemented in chipset 120 as protected memory table 128 and protected memory table 142 may be eliminated. In another embodiment, the protected memory table is implemented as protected memory table 142 in memory 140 as previously described and protected memory table 128 may be eliminated. The protected memory table may also be implemented in other ways not shown. Regardless of physical location, the purpose and basic operation of the protected memory table may be substantially as described.

In one embodiment, protected registers 126 are registers that are writable only by commands that may only be initiated by trusted microcode in processors 110. Protected microcode is microcode whose execution may only be initiated by authorized instruction(s) and/or by hardware that is not controllable by unauthorized devices. In one embodiment, protected registers 126 hold data that identifies the locations of, and/or controls access to, protected memory table 142 and trusted s/w monitor 144. In one embodiment, protected registers 126 include a register to enable or disable the use of protected memory table 142 so that the DMA protections may be activated before entering a protected operating environment and deactivated after leaving the protected operating environment. Protected registers 126 may also include a writable register identifying the location of protected memory table 142, so that the location does not have to be hardwired into the chipset.

In one embodiment, protected registers 126 may include the temporary location of the trusted s/w monitor 144 before it is placed into protected locations of memory 140, so that it may be located for the transfer. In one embodiment, protected registers 126 may include an execution start address of the trusted s/w monitor 144 after the transfer into memory 140, so that execution may be transferred to trusted s/w monitor 144 after initialization of the protected operating environment.

Physical token 150 may be a circuit to protect data related to creating and maintaining a protected operating environment. In a particular embodiment, physical token 150 includes key 152, which may be an embedded key to be used for specific encryption, decryption and/or validation processes. Physical token 150 may also include storage space to be used to hold a digest value and other information to be used in the protected operating environment. In one embodiment the storage space in physical token 150 may include non-volatile memory (e.g., flash memory) to retain its contents in the event of power loss to the physical token.

In one embodiment, media interface 170 is a disk controller while media 180 is a system disk. Authenticated code (AC) module 190 may be a software module, which when executed in private memory 160 will at least partially prepare the system 100 for a protected operating environment in the manner described herein.

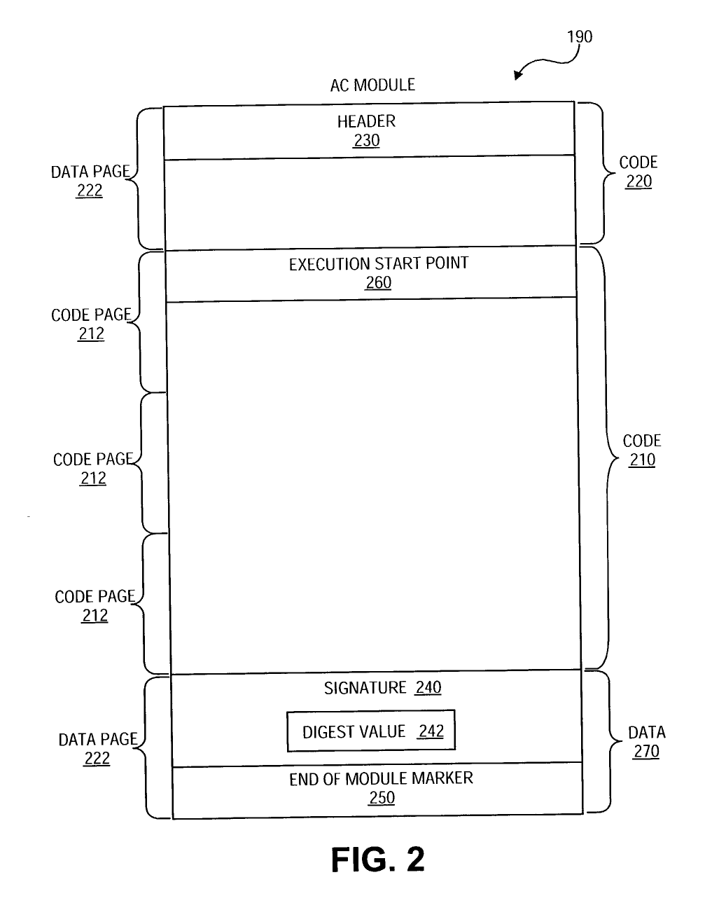

FIG. 2 shows components of an authenticated code module, according to one embodiment of the invention. In the illustrated embodiment, AC module 190 contains the data elements and code elements described below, but other embodiments, may contain other elements and/or may be arranged in a different configuration. Data 220 includes header 230 which may contain various identification information for AC module 190 including but not limited to: (1) identification of the module as authenticated code; (2) version and/or revision levels for the AC module; (3) offset pointers identifying the location of other elements within the AC module; and (4) the size of the AC module so that the end of module may be computed. Data 220 may also include other information pertaining to the module itself, including its contents and/or intended use. Code 210 may include all executable code contained within AC module 190 including execution start point 260 at which execution of the code is to begin. Data 270, in the illustrated embodiment, may include signature 240, which may in turn include or be based on digest value 242. These values may be used to authenticate AC module 190 to prove that it is an authorized module and that it has not been modified since it was produced. Data 270 may also include an end of module marker 250, which may be used to identify the end of AC module 190 in lieu of a calculated value for the end of AC module 190 derived from the aforementioned size value. In the illustrated embodiment, data and code are kept in separate pages, but other embodiments may not segment data and code in this way. AC module 190 also shows a division into the various pages including data pages 222 and code pages 212 with both data and code being contained within page boundaries. Other embodiments may operate without this page boundary limitation.

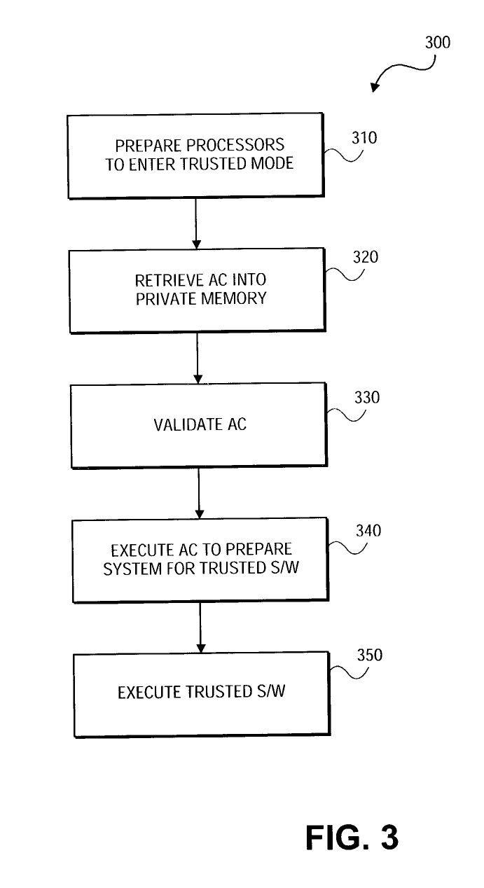

FIG. 3 shows a flowchart of a process to prepare a system for operating in a protected operating environment, according to one embodiment of the invention. Although the description of flowchart 300 may make references to the elements of FIGS. 1 and 2, it is understood that FIGS. 1, 2 and 3 may be implemented independently of each other. In the illustrated embodiment of FIG. 3 at block 310, the process begins by preparing the processors to enter a protected mode. This may include such operations as alerting each processor to the fact that a protected mode is to be implemented imminently so that each processor can suspend non-protected processing and prepare all affected registers, memory and other elements to enter the protected operating environment. At block 320, the AC module is retrieved from storage and placed into a private memory. With reference to FIG. 1, AC module 190 may be retrieved from disk and placed into private memory 160 in one of the processors 110, which may be referred to as the initiating logical processor (ILP). Once the AC module is located in private memory which has been isolated to protect it from tampering by devices other than the host processor, the AC module may be validated. In one embodiment, this includes using a digital signature and/or a hash digest to verify that the AC module currently located in private memory is the same AC module that was intended to be used in these circumstances. Specific details of validation are not described here to avoid obscuring various embodiments of the invention. Once the AC module has been validated, it may be executed to prepare the system for the operation of trusted software, for example a trusted s/w monitor. This execution is described in more detail later. In one embodiment, execution may take place entirely within private memory 160 so that it cannot be tampered with during execution. Once the AC module has been executed, it may turn execution over to the trusted s/w monitor at block 350. The AC module may be erased from private memory before turning over execution to the trusted s/w monitor.

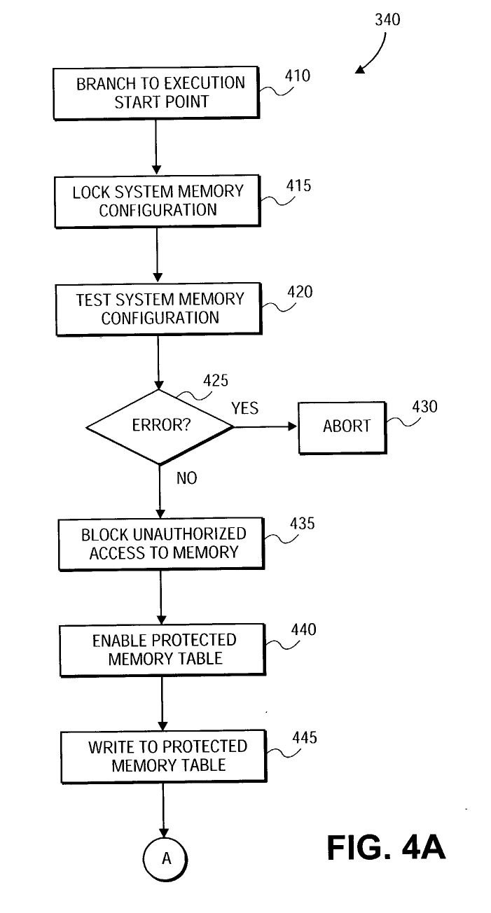

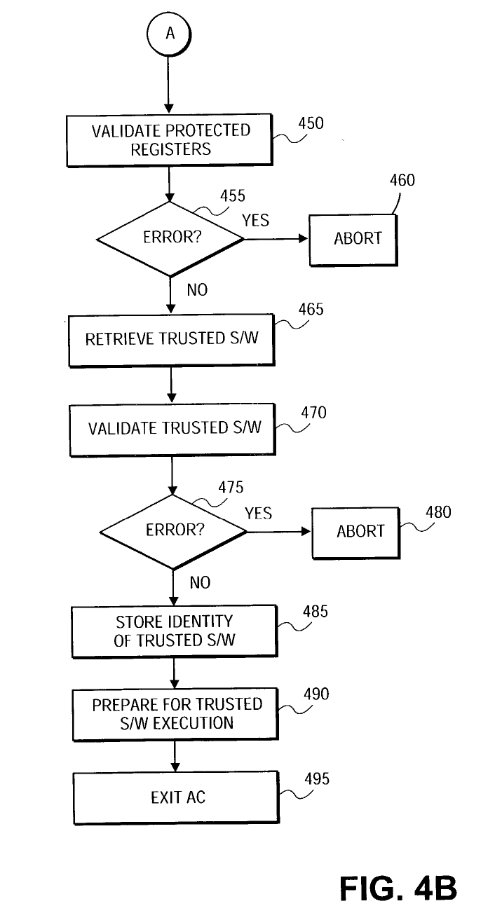

FIGS. 4A, 4B show a flowchart of a process to execute authenticated code, according to one embodiment of the invention. Flow chart 340 of FIGS. 4A, 4B show an expanded description of block 340 in FIG. 3. In FIG. 4A, blocks 410-445 show a process that permits protected code to place selected portions of memory in a protected operating mode so that non-protected hardware and non-trusted software cannot access those portions of memory. In FIG. 4B, blocks 450-495 show a process for validating protected registers, placing trusted software into protected memory for execution, validating the trusted software before executing it, and registering a validation value for the trusted software into a non-volatile location so that recovery from an interruption in processing may be able to re-validate the trusted software before resuming execution.

After validating the AC module (e.g., block 330 in FIG. 3), control may branch to the execution start point of the AC module at block 410. At block 415, the system memory configuration may be locked to prevent its modification. With reference to FIG. 1, in one embodiment the memory configuration may be locked by writing a LockMemConfig command to logic circuit 120, which may set one or more bits in a command register in protected registers 126. In a particular embodiment, the command register may include bits that control various operations in the protected operational environment. After locking the memory configuration, the memory configuration may be tested at block 420 for various irregularities (e.g., for possible address aliasing errors that allow non-protected code to access protected memory locations by double aliasing the same memory location). Such testing may be performed with code executing in processor 110, with portions of chipset 120 enabling the testing by conveying control signals and data between memory controller 122 and processor 110.

If an error in the memory configuration is detected at block 425, the process may be aborted at block 430. In the event of an abort, various actions may be taken. In one embodiment, a flag in an error status register is set with the flag corresponding to the particular error that was discovered. Subsequent to recording the error in the error status register, a crash command may be written to a command register to cause the chipset to force an immediate system reset. Other responses to error detection may also be used.

If no errors are detected at block 425, unauthorized access to system memory may be restricted at block 435 to prevent the subsequent operations from being modified or interfered with by non-protected hardware and/or non-trusted software. In one embodiment, this restriction includes blocking all DMA accesses to system memory by writing a BlockDMA command to set one or more bits in at least one of the protected registers 126. An UnblockDMA command may subsequently remove this restriction. Stopping all DMA access to all system memory may prevent interference with subsequent operations that establish which areas of system memory are protected and which are unprotected.

At block 440, a protected memory table is enabled. The protected memory table identifies which portions of memory are designated as protected memory and therefore are subject to various operational protections, and which portions are designated as non-protected memory. In one embodiment, when the protected memory table is disabled, all system memory is considered non-protected regardless of the contents of the table. In a particular embodiment, the protected memory table is used to prevent DMA accesses to any portion of memory designated in the table as protected, while permitting DMA accesses to those portions of memory designated as non-protected unless otherwise restricted. In one embodiment the protected memory table is contained in a designated block of addressable space in memory 140 (e.g., protected memory table 142 in FIG. 1). In another embodiment the protected memory table is contained in an addressable portion of hardware external to system memory (e.g. protected memory table 128 in chipset 120 in FIG. 1).

At block 445, certain memory blocks are defined as protected by writing into the protected memory table. In one embodiment, all bits in the table are written to assure that holdover data from a previous operation does not cause incorrect table entries. If the protected memory table is implemented in memory 140, the portion of memory containing the protected memory table may be protected by designating that portion as protected through the proper entries in the protected memory table, thus allowing the protected memory table to protect itself from alteration by DMA accesses.

In a particular embodiment, DMA access to the protected memory table while the table is being written may be prevented without the blanket lockout of block 435 by having block 445 perform the following sequential operations: 1) protect the portion of memory containing the protected memory table by writing ‘protect’ bits to the relevant portion of the table, 2) protect all remaining portions of memory by writing ‘protect’ bits to the full table, and 3) write ‘non-protect’ bits to all portions of memory that are to be designated as non-protected.

Although the operation of writing to the protected memory table is shown at block 445 in the illustrated embodiment, other embodiments may write to various portions of the table at a later time as new requirements for protected memory are determined.

After block 445, the operation of flow chart 340 continues at point ‘A’ in FIG. 4B. At block 450, the contents of at least some protected registers are checked to validate that the contents are proper for a secure operating environment. In the embodiment of FIG. 1, protected registers 126 are checked to validate their contents. The exact data to be validated may be chip-set specific, i.e., may depend on the specific design of chipset 120. In one embodiment the exact data to be validated may also depend on the specific design of hardware and/or software external to chipset 120 (e.g., keys 124 and 152, physical token 150, etc.)

If the validation of protected registers produces an error at block 455, indicating the contents of the protected registers are not proper to continue, the process may be aborted at block 460. While in one embodiment any error causes an abort, in another embodiment some incorrect register contents may be corrected, allowing the validation process to continue. In one embodiment the abort process is the same as previously described for block 430, but other embodiments may follow a different abort process.

At block 465, a trusted software module may be retrieved. In one embodiment the trusted software module is a trusted s/w monitor, but other modules with other labels and other operational purposes may also be used. In one embodiment, the trusted software is a trusted s/w monitor that monitors and controls protected operations within the protected operating environment. The trusted software may be placed in protected memory (i.e., in memory designated as protected by the protected memory table) to protect it from alteration during validation and execution. Validation of the trusted software at block 470 may take various forms including but not limited to generating a cryptographic value for the trusted software and comparing the cryptographic value with a stored protected value (e.g., key 116, key 124, key 152, etc.) to prove the trusted software an authorized software module. While in one embodiment the cryptographic value may be a hash value, in other embodiments the cryptographic value may take other forms (e.g., a digital signature). In one embodiment the validation may be performed by validation code running in private memory 160, that validates the trusted software located in protected portions of memory 140, but other forms of validation may be used in other embodiments.

Validating the trusted software may also include verifying that the placement of the code of the trusted software in memory obeys any rules governing such placement. Such rules may include but are not limited to: 1) some portions of the code may be required to be in physically contiguous pages; 2) the System Management Interrupt (SMI) handler maybe required to be placed in protected memory; (3) protected pages may be required to be within a predetermined memory range or excluded from a predetermined memory range; and (4) no protected memory blocks may be allowed to overlap any device memory address.

If the validation produces an error at block 475, indicating the trusted software is not authorized, the process may be aborted at block 480. In one embodiment the abort process is the same as previously described for block 430, but other embodiments may follow a different abort process.

If the trusted software is validated without error, an identifying characteristic of the trusted software may be determined and stored in a non-volatile protected location at block 485. In one embodiment the non-volatile protected location is in physical token 150. In one embodiment the identifying characteristic is a cryptographic value generated for the trusted software, but other embodiments may use other identifying characteristics. In various embodiments, the cryptographic value may be derived as a hash value, a digital signature, etc. In the event that the protected operating environment must be recreated at a future time (e.g., a system reset), the stored identifying characteristic may be used to prove that the trusted software obtained on resumption of processing is the same trusted software that was operating before the interruption.

At block 490, the system may be prepared for execution of the trusted software. In one embodiment, this preparation includes scrubbing private memory so that code and/or data used in the execution of the AC module will not subsequently be exposed if access restrictions to the private memory are removed. In one embodiment, scrubbing includes overwriting substantially all of private memory with certain data to eliminate the instructions and/or data previously contained therein. The data used for overwriting may take various forms, including but not limited to one or more of: 1) all logic 1's, 2) all logic 0's, 3) a repetitive data pattern, and 4) random data.

In one embodiment, the previously-mentioned UnblockDMA command, or its equivalent, may be issued at this point to remove the blanket restriction on all DMA accesses to memory 140, thus opening up non-protected memory to DMA accesses. In another embodiment, the UnblockDMA command or its equivalent may be issued before or after this point.

At block 495, the authenticated code module is exited. In one embodiment, exit includes invoking execution of the trusted software by transferring control to an execution start point of the trusted software (e.g., by using a location pointer previously stored in one of protected registers 126 to obtain the execution start point).

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. A method, comprising:
preparing a computer system for a trusted operating environment by testing a memory configuration;
checking at least one protected register for a content compatible with protected operation of the trusted operating environment;
placing trusted software into at least one memory block defined as protected in the memory configuration;
validating the trusted software; and
aborting said preparing in response to an error detected by any of said testing, said checking, and said validating.

2. The method of claim 1, wherein:
said testing includes testing for at least one address aliasing error.

3. The method of claim 1, wherein:
said testing includes locking said memory configuration.

4. The method of claim 1, wherein:
said validating includes validating the trusted software subsequent to said placing.

5. The method of claim 1, wherein:
said validating includes generating a cryptographic value for the trusted software and placing the cryptographic value in protected hardware.

6. The method of claim 1, wherein:
said testing, said checking, said placing and said validating are performed by executing instructions located in a private memory associated with a processor.

7. The method of claim 6, further comprising:
scrubbing the private memory subsequent to said testing, said checking, said placing, and said validating; and
invoking execution at an execution start point in the trusted software.

8. The method of claim 1, wherein:
said aborting includes at least one of setting an error flag, recording an error in an error status register, writing a crash command, and initiating a system reset.

9. An apparatus, comprising:
a logic circuit to be coupled between a processor and a memory to control access to the memory, the logic circuit including at least one register to enable controlled access to protected operations.

10. The apparatus of claim 9, wherein:
said controlled access includes access to selected memory blocks based on a content of a table.

11. The apparatus of claim 10, wherein:
the logic circuit is to lock a configuration of the memory; and
enable testing the configuration.

12. The apparatus of claim 10, wherein:
the logic circuit is to write data into the table identifying the selected memory blocks for use by the protected operations.

13. The apparatus of claim 10, wherein:
the logic circuit is further to transfer trusted software into at least one of the selected memory blocks.

14. The apparatus of claim 13, wherein:
the logic circuit is to store in a protected hardware location a hash value for the trusted software.

15. The apparatus of claim 14, wherein:
the protected hardware location is in a physical token.

16. A system, comprising:
a processor;
a volatile memory; and
a logic circuit coupled between the processor and the volatile memory to control access to the volatile memory, wherein the logic circuit in response to at least one command initiated by the processor is to lock a configuration of the volatile memory;
enable testing of the configuration;
write into a table indicators of protected address ranges in the volatile memory; and
write trusted software into the protected address ranges.

17. The system of claim 16, wherein:
the processor includes a private memory; and
the at least one command is to be initiated by execution of at least one instruction in the private memory.

18. The system of claim 16, wherein:
the logic circuit is to protect the table against access by direct memory access transactions during said writing into the table.

19. The system of claim 16, further comprising:
a physical token;
wherein the processor is to generate a validation indicator for the trusted software and place the validation indicator in the physical token.

20. The system of claim 19, wherein:
the validation indicator includes a digital signature.

21. The system of claim 19, wherein:
the validation indicator includes a hash value.

22. A machine-readable medium that provides instructions, which when executed by a computing device, cause said computing device to perform operations comprising:
retrieving trusted software;
placing the trusted software into one or more memory blocks within a system memory, the one or more memory blocks designated as protected memory blocks by a table; and
validating the trusted software.

23. The medium of claim 22, further comprising:
writing to the table to designate certain memory blocks as the protected memory blocks prior to said placing.

24. The medium of claim 23, wherein:
said writing includes writing to designate certain memory pages as protected memory pages.

25. The medium of claim 23, further comprising:
issuing a command to stop all direct memory accesses to system memory prior to said writing.

26. The medium of claim 22, wherein:
said validating includes generating a cryptographic value for the trusted software and comparing the cryptographic value to a protected stored value.

27. The medium of claim 22, further comprising:
preparing to execute the trusted software.

28. The medium of claim 27, wherein:
said preparing includes scrubbing a private memory containing instructions to execute said retrieving, said placing, and said validating.
